(19) United States
(12) Patent Application Publication
(10) Pub. No.: US 2003/0174975 A1
(43) Pub. Date: Sep. 18, 2003

(54) Optical connector

(76) Inventors: Yoshiaki Ohbayashi, Nara (JP); Keiji Mine, Osaka (JP); Hiroshi Nakagawa, Kyoto (JP)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 10/367,368

(22) Filed: Feb. 14, 2003

(30) Foreign Application Priority Data
Feb. 22, 2002 (JP) 2002-046000

(51) Int. Cl. G02B 6/42

(52) U.S. Cl. 385/88

(57) ABSTRACT

In an optical connector mounted in an optical transmitting gear to transmit an input signal after conversion to an optical signal, there are provided a detecting circuit for detecting the state of the input signal and a control circuit for controlling the power supply to a drive circuit for a light emitting element in accordance with the result of detection by the detecting circuit. On detecting the absence of the input signal by the detecting circuit, the control circuit cuts off or suppresses the power supply to the drive circuit—this permits reduction of power consumption while no optical transmission is performed (that is, when the optical transmitting gear is not in use).

### BACKGROUND OF THE INVENTION

The present invention relates to an optical connector which is mounted in an optical transmitting or receiving gear to transmit or receive optical signals over an optical fiber cable.

It is now practiced to transmit an audio signal in optical form over an optical fiber cable connected, for instance, between portable CD (Compact Disc), DVD (Digital Versatile Disc) and MD (Mini Disc) players.

When the power supply of such equipment is in the ON state, the insertion of an optical plug attached to the tip of the optical fiber cable into an optical connector loaded in the equipment usually turns ON the power supply of the optical connector, supplying power to a drive circuit for an optical device built in the optical connector, such as a light emitting diode (LED) or photodiode (PD).

As described above, when the optical plug is inserted and held in the optical connector mounted in the conventional portable CD, DVD or MD player, even if it is not in use (that is, even if it neither transmits nor receives signals), power is supplied to the drive circuit for the optical device at all times, and consequently, power consumption is large. When these gears are battery-operated, current flows to the drive circuit on the order of several mA, for instance, presenting a problem of seriously reducing the battery life.

### SUMMARY OF THE INVENTION

It is therefore an object of the present invention to provide an optical connector intended for low power consumption.

The optical connector according to the present invention comprises: an optical element for photoelectric conversion; a drive circuit for driving the optical element; detector means for detecting the state of an input signal; and control means for controlling the power supply to said drive circuit in accordance with the result of detection by said detector means. On detecting the absence of said input signal by said detector means, said control means cuts off or suppresses the power supply to said drive circuit.

The optical connector is mounted in an optical transmitting gear to transmit an input electric signal after conversion to an optical signal, and said optical element is a light emitting element, and said detector means detects the state of an input electric signal provided as said input signal.

Alternatively, the optical connector is mounted in an optical receiving gear to output an input optical signal after conversion to an electric signal, and said optical element is a light receiving element for converting the input optical signal to an electric signal, and said detector means detects the state of the electric signal from said light receiving element.

The optical connector may be provided with an external terminal for outputting said detection result as a detected signal.

### BRIEF DESCRIPTION OF THE DRAWINGS

FIG. 1 is a block diagram illustrating the configuration of the principal part of an embodiment of the optical connector according to the present invention;

FIG. 2 is a timing chart showing the operation of the FIG. 1 embodiment;

FIG. 3A is a plan view showing the outward appearance of the FIG. 1 embodiment;

FIG. 3B is a front view showing the outward appearance of the FIG. 1 embodiment;

FIG. 3C is a side view showing the outward appearance of the FIG. 1 embodiment;

FIG. 4A is an enlarged plan view of a photoelectric conversion part;

FIG. 4B is an enlarged front view of the photoelectric conversion part;

FIG. 4C is an enlarged side view of the photoelectric conversion part;

FIG. 5 is a block diagram illustrating the configuration of the principal part of another embodiment of the optical connector according to the present invention;

FIG. 6 is a block diagram illustrating the configuration of the principal part of still another embodiment of the optical connector according to the present invention;

FIG. 7A is a plan view showing the outward appearance of the optical connector according to the FIG. 5 embodiment;

FIG. 7B is a plan view showing the outward appearance of the optical connector according to the FIG. 5 embodiment;

FIG. 7C is a side view showing the outward appearance of the optical connector according to the FIG. 5 embodiment;

FIG. 8A is a plan view showing the outward appearance of the optical connector according to the FIG. 6 embodiment;

FIG. 8B is a front view showing the outward appearance of the optical connector according to the FIG. 6 embodiment; and

FIG. 8C is a side view showing the outward appearance of the optical connector according to the FIG. 6 embodiment.

### DETAILED DESCRIPTION OF THE PREFERRED EMBODIMENTS

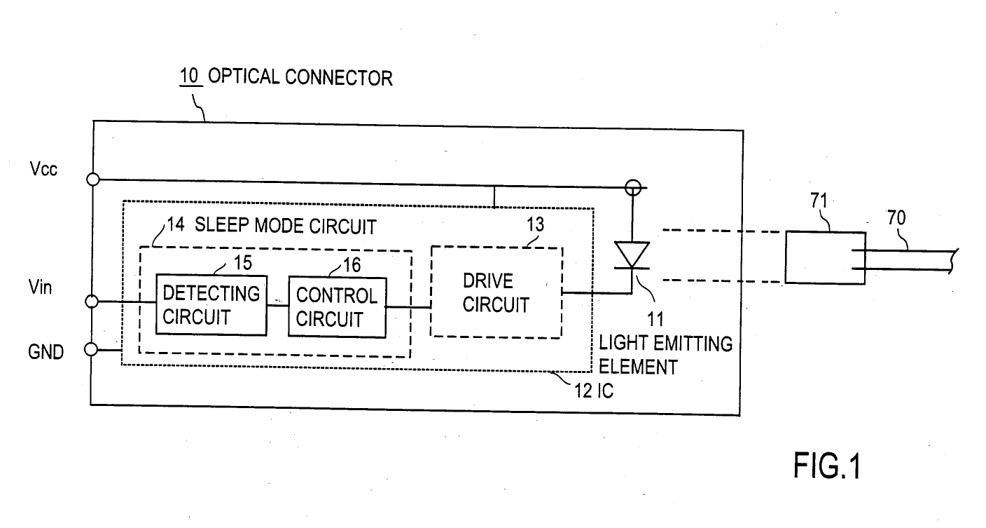

FIG. 1 illustrates in block form the configuration of the principal part (a photoelectric conversion part) of an optical connector 10 which is loaded, for example, in an optical transmitting gear to transmit an input signal in optical form. Reference numeral 11 denotes a light emitting element and 12 an IC. The light emitting element 11 is, in this example, a light emitting diode (LED).

The IC 12 has a drive circuit 13 for the light emitting element 11 and, in this example, a built-in sleep mode circuit 14.

The sleep mode circuit 14 is provided with a detecting circuit 15 for detecting the state of an input electric signal from an input terminal Vin and a control circuit 16 for controlling the power supply to the drive circuit 13 from a power supply terminal Vcc in accordance with the result of detection by the detector circuit 15. In this example, when the detecting circuit 15 decides that no signal is present at the terminal Vin, the control circuit 16 suppresses the power supply from the terminal Vcc to the drive circuit 13.

A description will be given below of the operation of the optical connector 10 loaded in a portable CD player.

Now, let it be assumed that the portable CD player is in the ON state and that an optical plug 71 attached to the tip of an optical fiber cable 70 is inserted in the optical connector 10. For example, when no optical signal is transmitted (that is, when the portable CD player is not in use) as in the case of the STOP or PAUSE mode, it is recognized that an input signal from DSP (Digital Signal Processor) of the portable CD player to the input terminal Vin is a signal continuously remaining at the low level (i.e., at the “0” level), that is, it is recognized that no input signal is being supplied, and the sleep mode circuit 14 goes into the sleep mode, decreasing current in the drive circuit 13, for instance, on the order of 10 μA or less to place it in the wait state.

When the portable CD player enters the PLAY mode and an audio format signal (a bi-phase signal of about 2.8 Mbps in the case of CD) from DSP remains high over a certain period of time (for example, 1 msec), the sleep mode circuit 14 wakes up and the optical connector 10 returns to its normal state of operation. Accordingly, the provision of such a sleep mode circuit 14 in the optical connector would permit a sharp reduction of power consumption while not in use.

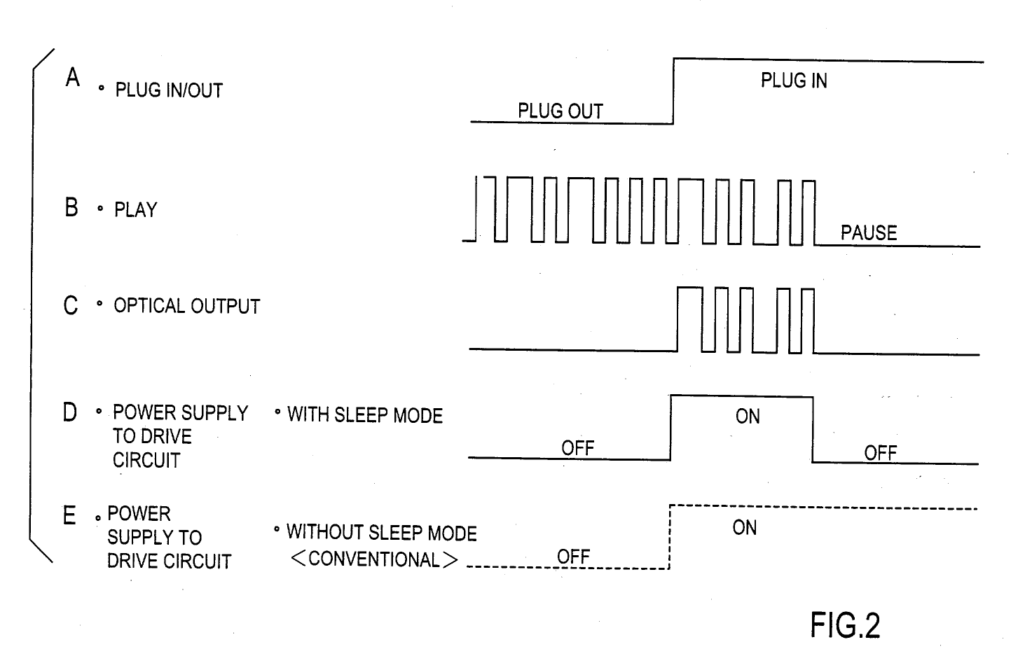

FIG. 2 is a timing chart showing the IN/OUT state of the optical plug 71 (Row A), the PLAY state of the portable CD player (Row B), the optical output state of the optical connector 10 (Row C) and the power supply to the drive circuit 13 (Row D) in such an operation as mentioned above. While the portable CD player is not in use (in the state of PAUSE), no power supply is provided to the optical connector and consequently to the light emitting element drive circuit 13 (that is, the power supply is held OFF). In a conventional optical connector with no sleep mode circuit, as indicated by the broken line in FIG. 2, the power supply to the drive circuit is maintained even during the PAUSE state.

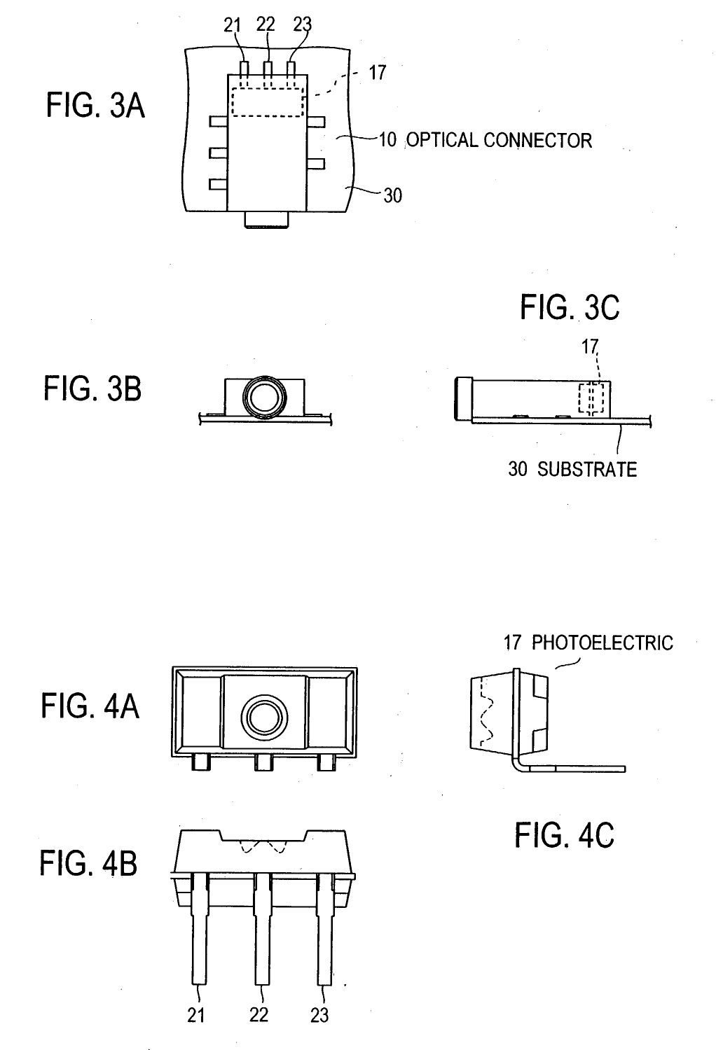

FIGS. 3A, 3B and 3C are plan, front and side views depicting an example of the outward appearance of the optical connector 10 provided with the sleep mode circuit 14. FIGS. 4A, 4B and C are enlarged plan, front and side views showing the photoelectric conversion part 17 built in the optical connector 10 and provided with the light emitting element 11 and IC 12. In FIGS. 3 and 4, reference numeral 21 denotes an input terminal (Vin), 22 a power supply terminal (Vcc) and 23 a ground terminal (GND). Reference numeral 30 denotes a substrate on which there is mounted the optical connector 10.

Next, another embodiment of the optical connector according to the present invention will be described below which is provided with a light receiving element for outputting an optical signal after conversion to an electric signal and is mounted in an optical receiving gear for receiving optical signals.

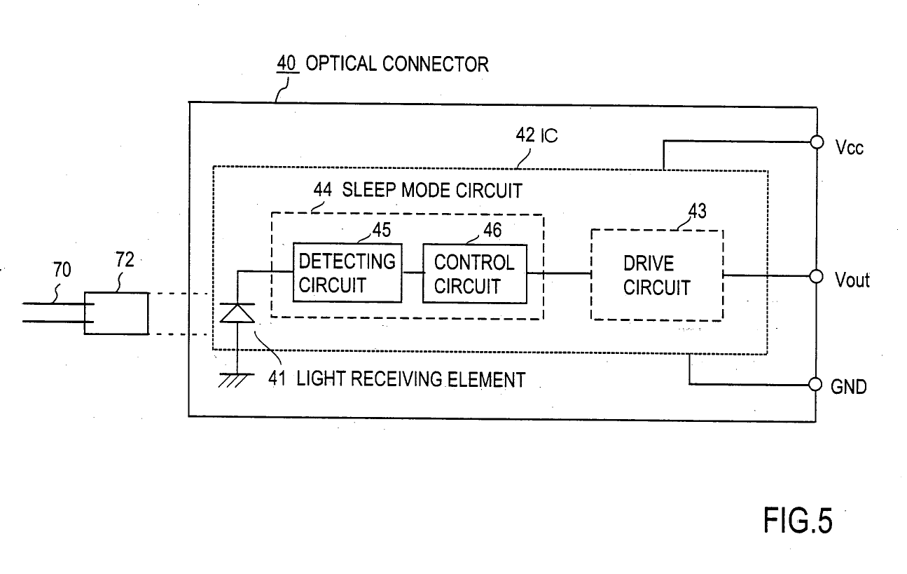

FIG. 5 illustrates in block form the configuration of the principal part (a photoelectric conversion part) of an optical connector 40 for receiving an optical signal. Reference numeral 41 denotes a light receiving element and 42 an IC. The light receiving element 41 in this example is formed as a photodiode (PD) in the IC 42, that is, the light receiving element 41 and the IC 42 are formed in a one-chip structure.

The IC 42 has a drive circuit 43 for the light receiving element 41 and a built-in sleep mode circuit 44.

The sleep mode circuit 44 is provided with a detecting circuit 45 for detecting the state of the output signal from the light receiving element 41 and a control circuit 46 for controlling the power supply to the drive circuit 43 from the power supply terminal Vcc in accordance with the result of detection by the detecting circuit 45. In this example, when the detecting circuit 45 decides that no signal is provided from the detecting circuit 45, the control circuit 46 suppresses the power supply to the drive circuit 43.

The operation of the optical connector 40 will be described below concretely in respect of the case where it is mounted in a portable MD player to input an optical digital audio output from a CD or DVD player to an MC player over an optical fiber cable.

Now, assume that the power supply of the portable MD is in the ON state and that an optical plug 72 attached to the tip of the optical fiber cable 70 is inserted in the optical connector 40. For example, when the portable CD or DVD player does not provide output light and hence is not in use, the sleep mode circuit 44 goes into the sleep mode, decreasing current in the drive circuit 13 on the order of 10 μA or less to place it in the wait state.

When the portable CD player or the like produces output light and the audio format signal (a bi-phase signal of about 2.8 Mbps in the case of the CD player) remains high over a certain period of time (for instance, 1 msec), the sleep mode circuit 44 wakes up and the optical connector 40 returns to its normal state of operation.

Accordingly, as is the case with the optical connector at the transmitting side, the provision of such a sleep mode circuit 44 in the optical connector 40 permits a sharp reduction of power consumption while the portable CD or DVD player is not in use.

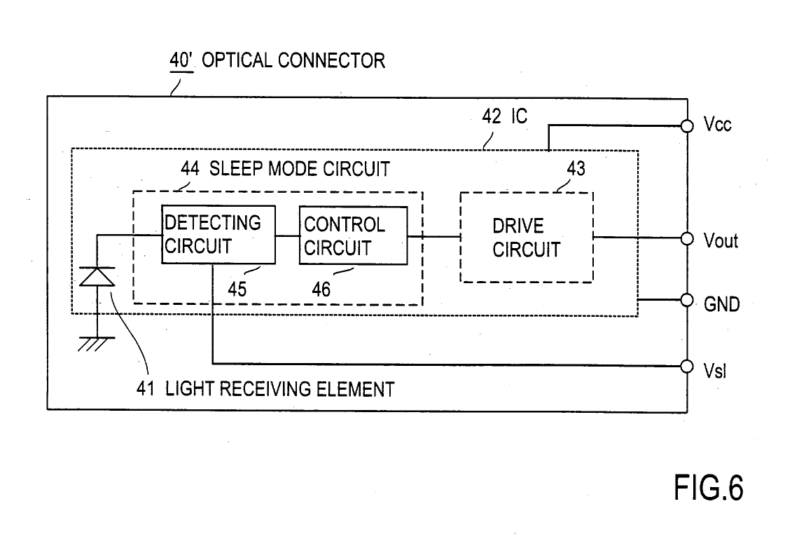

FIG. 6 illustrates in block form a modified form of the FIG. 6 embodiment, in which there is provided an external terminal Vsl through which the result of detection by the detecting circuit 45 is output as a detection signal. With such an optical connector 40′ as depicted in FIG. 6, the signal from its external terminal Vsl can be used, for example, at the DSP side, that is, current in the DSP itself can be limited in the sleep mode.

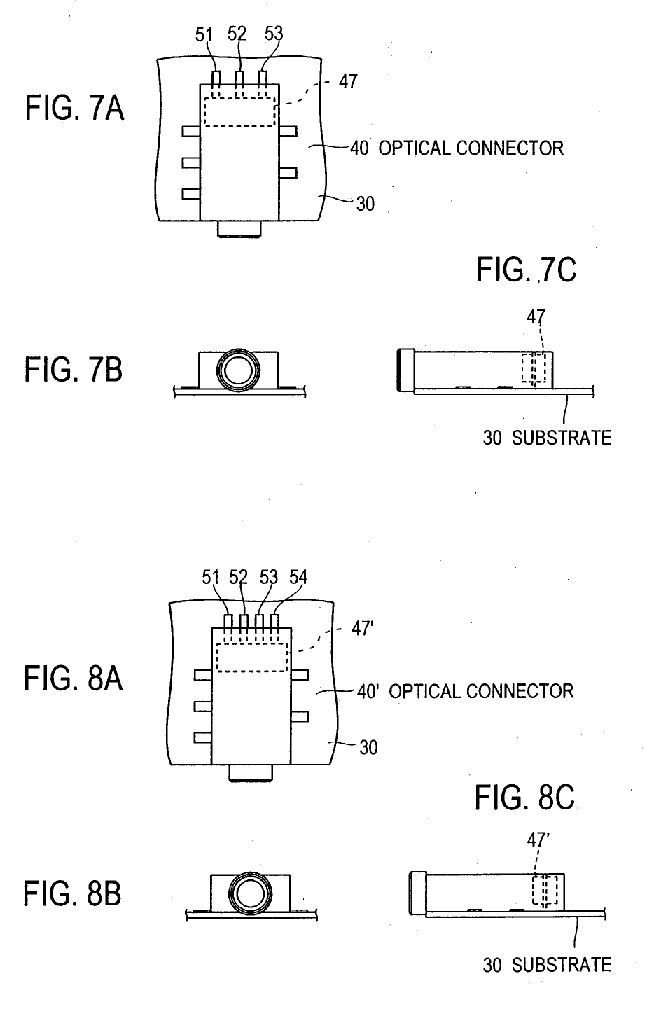

FIGS. 7A, 7B, 7C and FIGS. 8A, 8B, 8C show, by way of example, the outward appearances of the optical connectors 40 and 40′ mounted in the optical receiving gear. Photoelectric conversion parts 47 and 47′ built in these optical connectors 40 and 40′ are the same in shape as those depicted in FIGS. 4A, 4B and 4C, and hence they are not shown, but the light receiving element 41, the drive circuit 43 and the sleep mode circuit 44 are formed on the same chip. Reference numeral 51 denotes a power supply terminal (Vcc), 52 an output terminal (Vout) and 54 a terminal Vsl.

### EFFECT OF THE INVENTION

As described above, according to the present invention, since the optical connector cuts off or suppresses the power supply to the drive circuit for the optical device (the light emitting element) while no optical transmission or reception takes place, it is possible to reduce power consumption while the optical connector is not used.

Accordingly, when loaded in the optical transmitting or receiving gear, the optical connector reduces power consumption; for example, when such a gear is battery-operated, it is possible to reduce battery drain and hence make the battery last longer.

By mounting the optical connector of the present invention in either of the optical transmitting and receiving gears, the overall power consumption can be reduced most.

What is claimed is:

1. An optical connector comprising:
an optical element for photoelectric conversion;
a drive circuit for driving said optical element;
detecting means for detecting the state of an input signal; and
control means for controlling the power supply to said drive circuit in accordance with the result of detection by said detecting means;
wherein when said detecting means detects that said input signal is not present, said control means cuts off or suppresses the power supply to said drive circuit.

2. The optical connector of claim 1, which is an optical connector mounted in an optical transmitting gear to transmit an input electric signal after conversion to an optical signal, and wherein said optical element is a light emitting element and said detecting means detects the state of the input electric signal fed thereto as said input signal.

3. The optical connector of claim 1, which is an optical connector mounted in an optical receiving gear to output an input optical signal after conversion to an electric signal, and wherein said optical element is a light receiving element for converting the input optical signal thereto to an electric signal and said detecting means detects the state of the electric signal fed thereto from said light receiving element.

4. The optical connector of claim 2, further comprising an external terminal for outputting said result of detection as a detection signal.
